(19) United States
(12) Patent Application Publication
(10) Pub. No.: US 2023/0075028 A1
(43) Pub. Date: Mar. 9, 2023

(54) DOPED NICKEL-RICH LAYERED OXIDE MATERIAL AND LITHIUM ION BATTERY CONTAINING THE SAME

(71) Applicant: WILDCAT DISCOVERY TECHNOLOGIES, INC, San Diego, CA (US)

(72) Inventors: Cameron Peebles, Oceanside, CA (US); Tanghong Yi, San Diego, CA (US); Bin Li, San Diego, CA (US)

(21) Appl. No.: 17/446,367

(22) Filed: Aug. 30, 2021

(51) Int. Cl. H01M 4/525; H01M 4/505; H01M 4/36; H01M 10/0525

(52) U.S. Cl. CPC H01M 4/525; H01M 4/505; H01M 4/366; H01M 10/0525; H01M 2004/028

(57) ABSTRACT

A layered oxide material includes a bulk lattice, a niobium (Nb) dopant, and a second dopant. The bulk lattice includes lithium (Li), nickel (Ni), manganese (Mn), cobalt (Co), and oxygen (O). The second dopant includes one of aluminum (Al), gallium (Ga), indium (In), magnesium (Mg), tantalum (Ta), titanium (Ti), zinc (Zn), or zirconium (Zr).

### BACKGROUND

The present invention is in the field of battery technology, and, more particularly in the area of high-energy materials for use in electrodes of electrochemical cells.

High energy density materials are preferred for making certain types of lithium ion batteries. LiNiO₂ is a layered oxide material with high energy density, but is intrinsically unstable. One reason for instability is cation mixing in which the nickel ions move into lithium-containing layers in the LiNiO₂ layered oxide material, causing structural instability. The structural instability results in irreversible phase transitions in the cathode material, with release of oxygen from the structure. Both effects are detrimental to battery performance.

Historically, additional elements such as cobalt and manganese are substituted for some of the nickel in the structure to stabilize the material. Specifically, LiNi_{0.33}Mn_{0.33}Co_{0.33}O₂ (sometimes referred to in the battery industry as “NMC 111”) has been widely used in the battery industry. The capacity in these mixed metal layer oxides comes from the Ni^{2+/4+} and the Co^{3+/4+} redox couples. The majority of the manganese is assumed to be present as Mn⁴⁺. In an effort to increase the capacity, the battery industry is shifting to higher nickel content materials. However, these tend to be less stable as they are more similar to LiNiO₂ without the stabilizing influence of the other elements.

High nickel content, or nickel-rich, layered oxide materials can have the general chemical formula LiNiₓMn_{y}Co_{z}O₂ where x≥0.6 and x+y+z=1. Nickel-rich layered oxide materials offer high specific capacity, such as at least 200 mAh/g. Examples of such nickel-rich layered oxide materials include compositions referred to as NMC 622 (x=0.6, y=0.2, and z=0.2) and NMC 811 (x=0.8, y=0.1, z=0.1). A current challenge of implementing nickel-rich layered oxide materials as the cathode active material in electrochemical cells is rapid capacity fade, at even moderate voltages, due to structural degradation of the layered structure. For example, increasing the nickel content in the cathode material can increase cation mixing, resulting in irreversible changes from layered to rock salt structure, which causes impedance rise and capacity fade. The inability to stabilize the nickel-rich layered material has hindered the wide-spread application of this material in electrochemical cells.

It may be desirable to have high nickel content layered oxide materials that exhibit increased capacity retention, due to enhanced structural stability of the layered structure, for use as electrodes in electrochemical cells.

### BRIEF SUMMARY

In one or more embodiments, a layered oxide material is provided that includes a bulk lattice, a niobium (Nb) dopant, and a second dopant. The bulk lattice includes lithium (Li), nickel (Ni), manganese (Mn), cobalt (Co), and oxygen (O). The second dopant includes one of aluminum (Al), gallium (Ga), indium (In), magnesium (Mg), tantalum (Ta), titanium (Ti), zinc (Zn), or zirconium (Zr).

In one or more embodiments, a lithium ion battery is provided that includes a cathode, an anode, and an electrolyte. The cathode is capable of reversible intercalation of lithium ions. The cathode includes a layered oxide material, which has a bulk lattice, a niobium dopant, and a second dopant. The bulk lattice includes lithium, nickel, manganese, cobalt, and oxygen. The second dopant includes one of aluminum, gallium, indium, magnesium, tantalum, titanium, zinc, or zirconium. The electrolyte includes an organic solvent and a lithium salt.

In one or more embodiments, a method for producing a layered oxide material is provided. The method includes mixing stoichiometric amounts of multiple cathode precursors with a niobium doping agent and a second metal doping agent to form a mixture. The second metal doping agent includes one of aluminum, gallium, indium, magnesium, tantalum, titanium, zinc, or zirconium. The method also includes heating the mixture to synthesize the layered oxide material.

### BRIEF DESCRIPTION OF THE DRAWINGS

FIG. 1 is a graph plotting cycling capacity retention for four electrochemical test cells including cathode materials prepared with various dopants shown in Table 1.

FIG. 2 is a graph plotting cycling capacity retention for four electrochemical test cells including cathode materials prepared with various dopants shown in Table 3.

FIG. 3 is a flow chart for a method of producing a layered oxide material according to an embodiment.

### DETAILED DESCRIPTION

The following definitions apply to aspects described with respect to one or more embodiments of the inventive subject matter. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The term “active material” refers to the material in an electrode, particularly in a cathode, that donates, liberates, or otherwise supplies the conductive species during an electrochemical reaction in an electrochemical cell.

The term “metal” refers to alkali metals, alkaline earth metals, transition metals, lanthanides, and actinides as those terms are understood by one of ordinary skill in the art or as defined herein. The term “alkali metal” refers to any of the chemical elements in group 1 of the periodic table, including lithium (Li), sodium (Na), potassium (K), rubidium (Rb), cesium (Cs), and francium (Fr). The term “alkaline earth metal” refers to any of the chemical elements in group 2 of the periodic table, including beryllium (Be), magnesium (Mg), calcium (Ca), strontium (Sr), barium (Ba), and radium (Ra). The term “transition metal” refers to a chemical element in groups 3 through 12 of the periodic table, including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), and meitnerium (Mt). The term “post-transition metal” refers to aluminum (Al), gallium (Ga), germanium (Ge), indium (In), tin (Sn), antimony (Sb), thallium (Tl), lead (Pb), bismuth (Bi), and polonium (Po).

The rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values between the endpoints.

Embodiments of the inventive subject matter disclosed herein use dopants substituted into high nickel-content layered oxide materials, such as NMC 622 or NMC 811. The dopants are included to stabilize the high nickel-content layered oxide materials, as evidenced by an observed increase in capacity retention over battery cells with high nickel content layered oxide cathode materials that are not doped according to the disclosed embodiments. The embodiments are directed to a layered oxide cathode material, a lithium ion battery that uses the layered oxide cathode material, and a method for producing the layered oxide cathode material.

According to one or more embodiments, multiple dopants are incorporated into a bulk lattice structure of a nickel-rich layered oxide material. The multiple dopants can be two dopants, such that the layered oxide material is double-doped. The two dopants may stem from doping agents, or dopant precursors, that are incorporated into the bulk lattice during a mixing stage of a material synthesis process. The doping agents that provide the dopants may be simultaneously or concurrently added to the mixture, or alternatively may be consecutively added. The dopants may be incorporated into a bulk lattice that includes lithium (Li), nickel (Ni), manganese (Mn), cobalt (Co), and oxygen (O), such that the dopants are in addition to these elements within the bulk lattice. For example, the bulk lattice material may have a non-doped (or undoped) composition generally represented by the chemical formula LiNiₓMn_{y}Co_{z}O₂ where x≥0.6 and x+y+z=1. In at least one embodiment, the atomic ratio of the nickel in the bulk lattice to the manganese and cobalt is at least 3:1:1, such that there is at least three atoms of nickel for every atom of manganese and every atom of cobalt. In a first non-limiting example, the bulk lattice material is NMC 622, which has chemical formula LiNi_{0.6}Mn_{0.2}Co_{0.2}O₂. In a second non-limiting example, the bulk lattice material is NMC 811, which has chemical formula LiNi_{0.8}Mn_{0.1}Co_{0.1}O₂. As described herein, doping the NMC bulk lattice material with multiple dopants was observed to improve the cycle life of the material in an electrochemical cell, relative to the NMC material without the dopants.

One of the dopants in the layered oxide cathode material is the transition metal niobium (Nb). The layered oxide cathode material also includes at least one other metal dopant, referred to herein as a second dopant. The second dopant is present with the niobium in the bulk lattice material, replacing a portion of the lithium, nickel, manganese, and/or cobalt. The second dopant may be a transition metal, an alkaline earth metal, or a post-transition metal. According to one or more embodiments, the second dopant is aluminum (Al), gallium (Ga), indium (In), magnesium (Mg), tantalum (Ta), titanium (Ti), zinc (Zn), or zirconium (Zr). In a first example, the NMC bulk lattice is doped with a combination of niobium and aluminum. In a second example, the NMC bulk lattice is doped with a combination of niobium and gallium. The NMC bulk lattice is doped with niobium and indium in a third example, niobium and magnesium in a fourth example, niobium and tantalum in a fifth example, niobium and titanium in a sixth example, niobium and zinc in a seventh example, and niobium and zirconium in an eighth example. The niobium dopant and the second metal dopant may be present at low levels to stabilize the layered oxide material. Optionally, the layered oxide cathode material may include more than two dopants in the bulk lattice structure.

The bulk lattice is a layered crystal structure that has certain sites occupied by different elements of the composition. For example, lithium may occupy a first site, and the nickel, manganese, and cobalt may occupy another site of the layered crystal structure. The site occupied by the lithium is referred to herein as a alkali metal site, and the site occupied by the nickel, manganese, and cobalt is referred to herein as a transition metal site.

According to a first embodiment, the niobium dopant and the second dopant are doped onto the transition metal site occupied by the nickel, manganese, and/or cobalt. When the niobium dopant and the second dopant are doped at the transition metal site, the niobium and the second dopant replace a portion of the nickel, manganese, and cobalt without affecting the amounts of lithium and oxygen. According to a second embodiment, the niobium dopant and the second dopant are doped onto the alkali metal site occupied by the lithium. When the niobium dopant and the second dopant are doped at the alkali metal site, the niobium and the second dopant replace a portion of the lithium without affecting the amounts of nickel, manganese, cobalt, and oxygen.

In a non-limiting example, the composition of the bulk lattice is NMC 622, as shown by the chemical formula LizNi_{0.6}Mn_{0.2}Co_{0.2}O₂, where 0.95≤z≤1.1. In a non-limiting example composition, the variable z is 1.05. When the NMC 622 is doped by the niobium dopant and the second dopant at the transition metal site, the layered oxide material is represented by chemical formula (a):

Li_{z}Ni_{0.6-(x+y)/3}Mn_{0.2-(x+y)/3}Co_{0.2-(x+y)/3}NbₓM_{y}O₂ (a)

where x+y<0.6, 0.95≤z≤1.1, and M represents the second dopant. The variable M is one of aluminum, gallium, indium, magnesium, tantalum, titanium, zinc, or zirconium. In the non-limiting example in which z is 1.05, the chemical formula of the bulk lattice composition becomes Li_{1.05}Ni_{0.6-(x+y)/3}Mn_{0.2-(x+y)/3}Co_{0.2-(x+y)/3}NbₓM_{y}O₂.

As shown by formula (a), the addition of niobium and the second dopant replace approximately equal parts of the nickel, manganese, and cobalt metals in the layered crystal structure. For example, when the niobium is present at 1 mol % relative to the sum of the atoms at the transition metal site, the nickel content is reduced by 0.00333 (e.g., 1% or 0.01 divided by 3), the manganese content is reduced by 0.00333, and the cobalt content is reduced by 0.00333. In an embodiment, each of the niobium and second dopant is present at a relatively low level, such as no greater than 20 mol % relative to the percentage of total elements in the transition metal site. For example, in formula (a), the subscripts may be 0<x≤0.2 and 0<y≤0.2. In a first more specific example, 0<x≤0.1 and 0<y≤0.1. In a second more specific example, 0<x≤0.05 and 0<y≤0.05. In a third more specific example, 0<x≤0.02 and 0<y≤0.02. In a tested example, x and y are each approximately equal to 0.01 (e.g., the dopants are each 1 mol % in the transition metal site). When x=0.01 and y=0.01, the formula (a) becomes Li_{z}Ni_{0.59333}Mn_{0.19333}Co_{0.19333}Nb_{0.01}M_{0.01}O₂. In another tested example, x and y are each approximately equal to 0.005 (e.g., the dopants are each 0.05 mol %). In an embodiment, the dopants are present at approximately equal parts in the layered oxide material, such that x=y. In an alternative embodiment, the niobium dopant may be present at a greater mol % than the second metal dopant, or vice-versa.

In another non-limiting example, the composition of the bulk lattice is NMC 811, as shown by the chemical formula Li_{z}Ni_{0.8}Mn_{0.1}Co_{0.1}O₂, where 0.95≤z≤1.1. In a non-limiting example composition, the variable z is 1.05. When the NMC 811 is doped by the niobium dopant and the second dopant at the alkali metal site, the layered oxide material is represented by chemical formula (b):

Li_{z-x-y}Ni_{0.8}Mn_{0.1}Co_{0.01}NbₓM_{y}O₂ (b)

wherein x+y<z, 0.95≤z≤1.1, and M represents the second dopant. The variable M is one of aluminum, gallium, indium, magnesium, tantalum, titanium, zinc, or zirconium.

As shown by formula (b), the addition of niobium and the second dopant replace a portion of the lithium in the layered crystal structure. For example, when the niobium and the second dopant are each present at 1 mol % relative to a percentage of the total atoms in the alkali metal site, the lithium atomic content is reduced by 2 mol % (or 0.02). Stated differently, when x=0.01, y=0.01, and z=1.05 the formula (b) becomes Li_{1.03}Ni_{0.8}Mn_{0.2}Co_{0.2}Nb_{0.01}M_{0.01}O₂. Optionally, each of the niobium and second dopant is present at a relatively low level, such that the subscripts in formula (b) may be 0<x≤0.2 and 0<y≤0.2. In a first more specific example, 0<x≤0.1 and 0<y≤0.1. In a second more specific example, 0<x≤0.05 and 0<y≤0.05. In a third more specific example, 0<x≤0.02 and 0<y≤0.02. In a tested example, x and y are each approximately equal to 0.01 (e.g., the dopants are each 1 mol % at the alkali metal site). In another tested example, x and y are each approximately equal to 0.005 (e.g., the dopants are each 0.05 mol %). In an embodiment, the dopants are present at approximately equal parts in the layered oxide material, such that x=y. In an alternative embodiment, the niobium dopant may be present at a greater mol % than the second metal dopant, or vice-versa.

To test the performance of the doped layered oxide materials as the cathode of an electrochemical cell, test cells were assembled. First, nickel-rich layered oxide materials were formed according to the compositions shown in formulas (a) and (b). The layered oxide materials were synthesized via solid-state synthesis methods. To form the NMC 622 bulk lattice composition, cathode precursors were mixed with doping agents. The doping agents refer to precursor compounds that provide the dopants for the synthesized layered oxide materials, and can also be referred to as dopant precursors.

The cathode precursors included lithium hydroxide (LiOH), cobalt(II,III) oxide (or cobalt tetraoxide) (CO₃O₄), manganese(II) carbonate (MnCO₃), and nickel(II) hydroxide (Ni(OH)₂). The niobium doping agents for the various test cells included niobium oxide (Nb₂O₅) and ammonium niobium oxalate (“ANO”). For example, each test cell included either niobium oxide or ammonium niobium oxalate as the niobium doping agent that contributes niobium atoms. The second metal doping agents for the various test cells, which contributed the second dopant atoms, were aluminum oxide (Al₂O₃), gallium oxide (Ga₂O₃), indium oxide (In₂O₃), magnesium oxide (MgO), tantalum oxide (Ta₂O₅), titanium dioxide (TiO₂), zinc carbonate (ZnCo₃), or zirconium dioxide (ZrO₂). Each test cell included only one of the listed second metal doping agents.

For each test cell, stoichiometric amounts of the cathode precursors were mixed with a niobium doping agent, either niobium oxide or ANO, and one of the second metal doping agents to form a mixture. Each of the eight second metal doping agents was mixed with each of the two niobium doping agents to form sixteen different material compositions. Furthermore, two different amounts of the respective niobium doping agent and the second metal doping agent were tested for each of the sixteen compositions, thus yielding thirty-two individual doped NMC 622 layered oxide materials.

After mixing, the mixtures were heated to synthesize the doped NMC 622 layered oxide materials. The mixtures were heated under an oxygen air flow at 750° C. for 16 hours.

To form the NMC 811 bulk lattice composition, cathode precursors were mixed with doping agents. The cathode precursors included Ni_{0.8}Mn_{0.1}Co_{0.1}(OH)₂ and lithium carbonate (Li₂CO₃). These cathode precursors differed from the cathode precursors used to synthesize the NMC 622 bulk lattice. The doping agents used to form the NMC 811 bulk lattice were the same as used to form the NMC 622 bulk lattice. For each test cell, stoichiometric amounts of the cathode precursors Ni_{0.8}Mn_{0.1}Co_{0.1}(OH)₂ and lithium carbonate (Li₂CO₃) were mixed with one of the two niobium doping agents and one of the second metal doping agents to form a mixture. As with the NMC 622, two different amounts of the respective niobium doping agent and the second metal doping agent were tested for each of the sixteen compositions, thus yielding thirty-two individual doped NMC 811 layered oxide materials.

After mixing, one milliliter (mL) of water was added to the above mixture to homogenize the precursors and doping agents. Then, the homogenized mixtures were milled at ultra-low energy for a short period of time. These materials were then heated under an oxygen air flow at 850° C. for 20 hours to synthesize the doped NMC 811 layered oxide materials.

Battery cells were made in a high purity argon filled glovebox (M-Braun, O₂ and humidity content were both<0.1 ppm). The cathode was prepared by mixing the nickel-rich cathode material, synthesized as described above, with poly(vinylidene fluoride) (PVDF) and 1-methyl-2-pyrrolidinone (NMP) solvents. The resulting slurry was deposited on a current collector and dried to form a composite cathode film. For the anode, a thin lithium foil was used. Each battery cell included the composite cathode film, a polypropylene separator, and a lithium foil anode. An electrolyte was formed that included at least one lithium salt and at least one organic solvent. The electrolyte in the experimental test cells contained lithium hexafluororophosphate (LiPF₆) in a mixture of ethylene carbonate (EC) and ethyl methyl carbonate (EMC). The battery cells were sealed and cycled between 3.0 V and 4.25 V at 25° C. Sixty four candidate test cells were formed, including thirty two that have the doped NMC 622 layered oxide cathode material and third two having the doped NMC 811 layered oxide cathode material. The test cell compositions and experimental results are shown in Tables 1 and 3 below.

Table 1 shows properties of electrochemical test cells that have NMC 622 layered oxide cathode materials. The properties include 1^{st} cycle capacity (“Cy1 Cap”), 1^{st} cycle Coulombic efficiency (CE), and 140^{th} cycle capacity retention (“Cy140 Ret”) percentage relative to an earlier cycle of the same charge/discharge rate (e.g., the 1^{st} cycle capacity). The data of the 1^{st} cycle capacity is shown in units of mAh/g, and the 1^{st} cycle CE is shown in %. Thirty five cells were tested that were substantially identical in terms of chemical compositions and amounts except for the cathode active material.

Material 1 shown in the first row was a control cell for establishing a baseline for comparison purposes. The control cell included a NMC 622 layered oxide cathode material that was undoped (e.g., no niobium dopant). Materials 2 and 3 in the second and third rows, respectively, only contained the niobium dopant. Materials 2 and 3 each lacked a second dopant. In Material 2, the niobium doping precursor was niobium oxide, and the niobium doping precursor was ANO in Material 3.

Materials 4 through 35 are the thirty two test compositions described above which each included niobium and a second metal dopant doped in the transition metal site of the NMC 622 bulk lattice. The column “Nb Precursor” identifies the niobium doping precursor used in each composition as either niobium oxide (Nb₂O₅) or ANO. The column “M Precursor” identifies which of the eight second metal doping precursor is used in each composition. The column “Dopant Conc. (Nb/M) identifies the concentration of each of the two dopants in the cathode in each test cell. The concentrations are described in terms of mole percentage of the total transition metals in each composition.

TABLE 1
Cycling results of various double-doped NMC 622 samples.

| | | | | Cy1 Cap | | Cy1 CE | | Cy140 Ret |
|---|---|---|---|---|---|---|---|---|
| | Nb | M | Precursor | (C/10, C/10) | | (C/10, C/10) | | (C/2, C/2) |
| Material | Precursor | Precursor | Conc. | (mAh/g) | | (mAh/g) | | (%) |
| 1 | Baseline (no dopant) | | | 161.9 ± | 1.8 | 87.5 ± | 0.75 | 66.8% |
| 2 | Nb2O5 | — | 0.5% | 164.8 ± | 1.0 | 88.2 ± | 0.13 | 84.0% |
| 3 | ANO | — | 0.5% | 160.8 ± | 2.5 | 88.1 ± | 0.2 | 79.7% |
| 4 | Nb2O5 | Al2O3 | 0.5%/0.5% | 161.5 ± | 0.25 | 87.7 ± | 0.2 | 66.1% |
| 5 | Nb2O5 | Al2O3 | 1%/1% | 158.7 ± | 0.55 | 88.2 ± | 0.3 | 70.3% |
| 6 | ANO | Al2O3 | 0.5%/0.5% | 159.1 ± | 0.25 | 88.2 ± | 0.2 | 73.4% |
| 7 | ANO | Al2O3 | 1%/1% | 160.9 ± | 0.25 | 88.4 ± | 0.4 | 75.0% |
| 8 | Nb2O5 | Ga2O3 | 0.5%/0.5% | 159.9 ± | 0.65 | 88.2 ± | 0.45 | 70.1% |
| 9 | Nb2O5 | Ga2O3 | 1%/1% | 157.2 ± | 1.35 | 87.5 ± | 0.2 | 75.2% |
| 10 | ANO | Ga2O3 | 0.5%/0.5% | 158.9 ± | 2.25 | 88 ± | 0.4 | 75.8% |
| 11 | ANO | Ga2O3 | 1%/1% | 157.1 ± | 0.2 | 87.8 ± | 0.15 | 77.1% |
| 12 | Nb2O5 | In2O3 | 0.5%/0.5% | 157.8 ± | 2.95 | 87.9 ± | 0.05 | 76.1% |
| 13 | Nb2O5 | In2O3 | 1%/1% | 158.6 ± | 0.8 | 88.2 ± | 0.2 | 78.6% |
| 14 | ANO | In2O3 | 0.5%/0.5% | 156.5 ± | 0.35 | 87.7 ± | 0.2 | 78.4% |
| 15 | ANO | In2O3 | 1%/1% | 157.5 ± | 0 | 88.2 ± | 0.4 | 74.5% |
| 16 | Nb2O5 | MgO | 0.5%/0.5% | 161.9 ± | 0.25 | 88.3 ± | 0.05 | 72.7% |
| 17 | Nb2O5 | MgO | 1%/1% | 159.2 ± | 0.85 | 87.8 ± | 0.15 | 74.5% |
| 18 | ANO | MgO | 0.5%/0.5% | 157.3 ± | 0.55 | 87.8 ± | 0.05 | 71.7% |
| 19 | ANO | MgO | 1%/1% | 160.9 ± | 0.6 | 88.3 ± | 0.25 | 79.1% |
| 20 | Nb2O5 | Ta2O5 | 0.5%/0.5% | 159.7 ± | 1.2 | 88.8 ± | 0.35 | 79.9% |
| 21 | Nb2O5 | Ta2O5 | 1%/1% | 154.8 ± | 0.55 | 88.7 ± | 0.25 | 70.3% |
| 22 | ANO | Ta2O5 | 0.5%/0.5% | 157.9 ± | 0.3 | 88.9 ± | 0.15 | 80.7% |
| 23 | ANO | Ta2O5 | 1%/1% | 156.1 ± | 0.4 | 88.8 ± | 0.2 | 81.5% |
| 24 | Nb2O5 | TiO2 | 0.5%/0.5% | 161.9 ± | 0.45 | 88.9 ± | 0.1 | 72.5% |
| 25 | Nb2O5 | TiO2 | 1%/1% | 158.5 ± | 0.9 | 88.1 ± | 0.25 | 71.1% |
| 26 | ANO | TiO2 | 0.5%/0.5% | 160.2 ± | 1.1 | 88.1 ± | 0.75 | 73.7% |
| 27 | ANO | TiO2 | 1%/1% | 158 ± | 0.25 | 88.4 ± | 0.3 | 76.7% |
| 28 | Nb2O5 | ZnCO3 | 0.5%/0.5% | 151.8 ± | 0.45 | 84.4 ± | 0.3 | 70.9% |
| 29 | Nb2O5 | ZnCO3 | 1%/1% | 154.4 ± | 0.6 | 85.1 ± | 0.1 | 75.1% |
| 30 | ANO | ZnCO3 | 0.5%/0.5% | 154.2 ± | 0.6 | 86.1 ± | 0.1 | 72.7% |
| 31 | ANO | ZnCO3 | 1%/1% | 154.6 ± | 0.95 | 85.2 ± | 0.35 | 77.1% |
| 32 | Nb2O5 | ZrO2 | 0.5%/0.5% | 161.7 ± | 0.35 | 88 ± | 0.75 | 77.3% |
| 33 | Nb2O5 | ZrO2 | 1%/1% | 151.8 ± | 1.15 | 86.5 ± | 0.15 | 74.2% |
| 34 | ANO | ZrO2 | 0.5%/0.5% | 156.9 ± | 0.65 | 87.6 ± | 0.2 | 82.1% |
| 35 | ANO | ZrO2 | 1%/1% | 159.1 ± | 1.1 | 88 ± | 0 | 82.1% |

The data in Table 1 shows that over half (e.g., 17 out of 32) of the double-doped test cells retained at least 75% capacity after 140 discharge cycles. The best performers were Materials 34 and 35 which included ANO as the niobium doping agent and ZrO₂ as the second metal doping agent. Material 35 had 1% Nb dopant and 1% Zr dopant, while Material 34 had only 0.05% Nb and 0.05% Zr. This data shows that double-doping NMC 622 with Nb and Zr at the transition metal site at the designated concentrations yields 82.1% capacity retention after 140 cycles, and the capacity retention is unaffected by the difference in dopant concentration between the two compositions. Other material compositions that performed particularly well included Materials 22 and 23, which included ANO as the niobium doping agent and Ta₂O₅ as the second metal doping agent. Material 22 yielded 80.7% capacity retention after 140 cycles. Material 23, which had a greater dopant concentration than Material 22, yielded a slightly greater 81.5% capacity retention. Material 20, which had Ta₂O₅ as the second metal doping agent and niobium oxide as the niobium doping agent, also performed well with 79.9% capacity retention. The next best double-doped NMC 622 compositions were Material 19, then Material 13, and Material 14.

It is important to note that all of the double-doped compositions except for one, Material 4, showed substantially increased capacity retention than the baseline control composition (Material 1). Although varying the dopant concentration from 0.5% to 1% typically affected the capacity retention (e.g., except for Materials 34 and 35), the data did not show a correlation between dopant concentration and capacity retention. This data generally indicates that both tested dopant concentrations provide beneficial performance over the control composition, and also that the specific results were unpredictable. The data did not indicate a clear preference for the ANO niobium doping agent over the niobium oxide doping agent, or vice-versa. Furthermore, there was no indication that one of the second metal doping agents is clearly superior over the other second metal doping agents. For example, although ZrO₂ with ANO provided the best capacity retention, the same ZrO₂ doping agent used with niobium oxide yielded noticeably lower capacity retention in Materials 32 and 33.

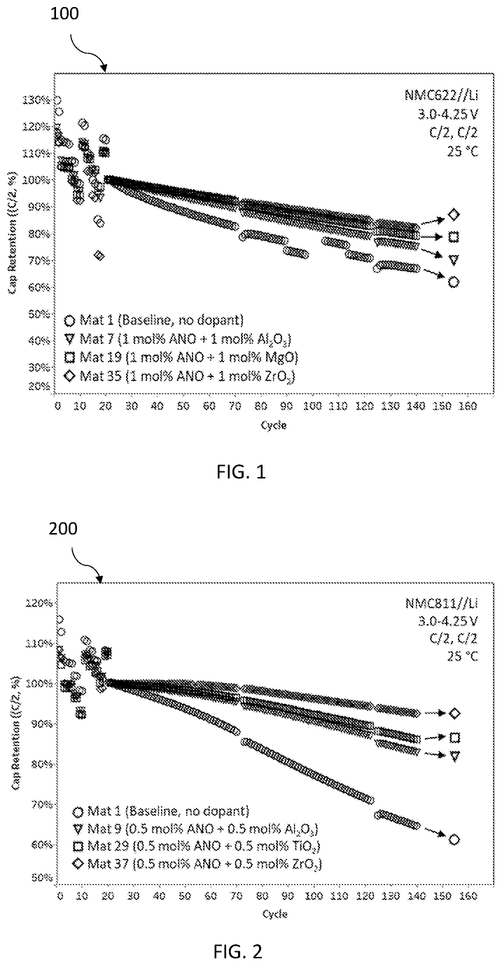

FIG. 1 is a graph 100 plotting cycling capacity retention for four of the test cells shown in Table 1. The plotted test cells include the baseline control cell (Material 1) and three double-doped layered oxide materials including Material 7, Material 19, and Material 35. The graph 100 indicates capacity retention in percentage over cycles 1 through 140. All three of the cells with double-doped layered oxide materials showed better capacity retention than the baseline control cell (circle in FIG. 1), starting at about the thirtieth cycle. Material 35 (diamond in FIG. 1) demonstrated the greatest capacity retention at the 140^{th} cycle, as described above with respect to Table 1.

An additional aspect of material improvement was rate performance. Prior to cycle life testing, all test cells were subject to a discharge rate test (0.1 C/2 C). Table 2 below shows the rate capability results of the 35 electrochemical test cells having NMC 622 layered oxide cathode materials shown in Table 1.

TABLE 2
Rate capability results of various double-doped NMC 622 samples.

| | | | | Cy9 Cap | | Cy9 Ret |
|---|---|---|---|---|---|---|
| | Nb | M | Precursor | (C/10, 2C) | | (C/10, 2C) |
| Material | Precursor | Precursor | Conc. | (mAh/g) | | (%) |
| 1 | Baseline (no dopant) | | | 123.5 ± | 5 | 76.3% |
| 2 | Nb2O5 | — | 0.5% | 133.1 ± | 4.0 | 80.3% |
| 3 | ANO | — | 0.5% | 133.8 ± | 2.7 | 81.9% |
| 4 | Nb2O5 | Al2O3 | 0.5%/0.5% | 127.8 ± | 0.2 | 79.2% |
| 5 | Nb2O5 | Al2O3 | 1%/1% | 122.9 ± | 0.7 | 77.5% |
| 6 | ANO | Al2O3 | 0.5%/0.5% | 121.1 ± | 0.85 | 76.1% |
| 7 | ANO | Al2O3 | 1%/1% | 129.1 ± | 0.5 | 80.2% |
| 8 | Nb2O5 | Ga2O3 | 0.5%/0.5% | 125.8 ± | 0.9 | 78.7% |
| 9 | Nb2O5 | Ga2O3 | 1%/1% | 121.1 ± | 1.9 | 77.0% |
| 10 | ANO | Ga2O3 | 0.5%/0.5% | 125.3 ± | 1.4 | 78.9% |
| 11 | ANO | Ga2O3 | 1%/1% | 121.8 ± | 1.25 | 77.6% |
| 12 | Nb2O5 | In2O3 | 0.5%/0.5% | 124.5 ± | 0.3 | 78.9% |
| 13 | Nb2O5 | In2O3 | 1%/1% | 123.9 ± | 0.9 | 78.1% |
| 14 | ANO | In2O3 | 0.5%/0.5% | 119.5 ± | 1 | 76.4% |
| 15 | ANO | In2O3 | 1%/1% | 128 ± | 0.15 | 81.3% |
| 16 | Nb2O5 | MgO | 0.5%/0.5% | 127.3 ± | 1.05 | 78.7% |
| 17 | Nb2O5 | MgO | 1%/1% | 126.5 ± | 0.9 | 79.5% |
| 18 | ANO | MgO | 0.5%/0.5% | 117.3 ± | 1.35 | 74.6% |
| 19 | ANO | MgO | 1%/1% | 129.4 ± | 0.85 | 80.4% |
| 20 | Nb2O5 | Ta2O5 | 0.5%/0.5% | 121.5 ± | 2.45 | 76.1% |
| 21 | Nb2O5 | Ta2O5 | 1%/1% | 109.6 ± | 1.35 | 70.8% |
| 22 | ANO | Ta2O5 | 0.5%/0.5% | 120.1 ± | 0.25 | 76.1% |
| 23 | ANO | Ta2O5 | 1%/1% | 115.3 ± | 0.7 | 73.8% |
| 24 | Nb2O5 | TiO2 | 0.5%/0.5% | 128.2 ± | 0.55 | 79.2% |
| 25 | Nb2O5 | TiO2 | 1%/1% | 116.2 ± | 7.15 | 73.3% |
| 26 | ANO | TiO2 | 0.5%/0.5% | 124.3 ± | 2 | 77.6% |
| 27 | ANO | TiO2 | 1%/1% | 123.3 ± | 0.95 | 78.0% |
| 28 | Nb2O5 | ZnCO3 | 0.5%/0.5% | 117.8 ± | 2.05 | 77.6% |
| 29 | Nb2O5 | ZnCO3 | 1%/1% | 123.4 ± | 1.6 | 79.9% |
| 30 | ANO | ZnCO3 | 0.5%/0.5% | 117.1 ± | 0.8 | 75.9% |
| 31 | ANO | ZnCO3 | 1%/1% | 124.6 ± | 0.5 | 80.6% |
| 32 | Nb2O5 | ZrO2 | 0.5%/0.5% | 130 ± | 0.55 | 80.4% |
| 33 | Nb2O5 | ZrO2 | 1%/1% | 110.5 ± | 4.45 | 72.8% |
| 34 | ANO | ZrO2 | 0.5%/0.5% | 123.5 ± | 1 | 78.7% |
| 35 | ANO | ZrO2 | 1%/1% | 124.9 ± | 5.95 | 78.5% |

Compared to the baseline (non-doped) control cell, several double-doped layered oxide cathode cells showed both higher absolute 2 C discharge capacity and higher 2 C discharge capacity retention (relative to the 2^{nd} cycle 0.1 C/0.1 C). The best double-doped materials for rate performance included Material 7 (e.g., Nb₂O₅ and ZrO₂ at 0.5/0.5 wt %), Material 15 (e.g., ANO and In₂O₃ at 1.0/1.0 wt. %), Material 19 (e.g., ANO and MgO at 1.0/1.0 wt %), Material 31 (e.g., ANO and ZnCO₃ at 1.0/1.0 wt. %), and Material 32 (e.g., ANO and Al₂O₃ at 1.0/1.0 wt %).

Table 3 shows properties of electrochemical test cells that have NMC 811 layered oxide cathode materials. The properties include 1^{st} cycle capacity (“Cy1 Cap”), 1^{st} cycle Coulombic efficiency (CE), and 140^{th} cycle capacity retention (“Cy140 Ret”) percentage relative to an earlier cycle of the same charge/discharge rate (e.g., the 1^{st} cycle capacity). The data of the 1^{st} cycle capacity in units of mAh/g and the 1^{st} cycle CE is in %. Thirty seven cells were tested that were substantially identical in terms of chemical compositions and amounts except for the cathode active material. Material 1 shown in the first row was a control cell for establishing a baseline for comparison purposes. The control cell included a NMC 811 layered oxide cathode material that was undoped (e.g., no niobium dopant). Materials 2 through 5 only contained the niobium dopant, such that these compositions lacked a second metal dopant. In Materials 2 and 3, the niobium doping agent was niobium oxide at 0.5% and 1.0% concentrations, respectively. The niobium doping agent was ANO in Materials 4 and 5. Materials 6 through 37 are the thirty two double-doped test compositions described above which each included niobium and a second metal dopant doped in the alkali metal site of the NMC 811 bulk lattice.

TABLE 3
Cycling results of various double-doped NMC 811 samples.

| | | | | Cy1 Cap | | Cy1 CE | | Cy140 Ret |
|---|---|---|---|---|---|---|---|---|
| | Nb | M | Precursor | (C/10, C/10) | | (C/10, C/10) | | (C/2, C/2) |
| Material | Precursor | Precursor | Conc. | (mAh/g) | | (mAh/g) | | (%) |
| 1 | Baseline (no dopant) | | | 195 ± | 1.15 | 90.4 ± | 0.35 | 64.6% |
| 2 | Nb2O5 | — | 0.5% | 197.5 ± | 0.4 | 90.0 ± | 0.4 | 86.6% |
| 3 | Nb2O5 | — | 1% | 188.3 ± | 0.7 | 88.4 ± | 0.4 | 91.6% |
| 4 | ANO | — | 0.5% | 197.1 ± | 0.8 | 90.2 ± | 0.2 | 76.5% |
| 5 | ANO | — | 1% | 192.3 ± | 0.7 | 88.5 ± | 0.2 | 90.5% |
| 6 | Nb2O5 | Al2O3 | 1%/1% | 182.7 ± | 0.3 | 85.2 ± | 0.3 | 97.5% |
| 7 | Nb2O5 | Al2O3 | 0.5%/0.5% | 194 ± | 0.15 | 87.3 ± | 0.35 | 91.3% |
| 8 | ANO | Al2O3 | 1%/1% | 192.8 ± | 1.85 | 88.1 ± | 0.75 | 92.8% |
| 9 | ANO | Al2O3 | 0.5%/0.5% | 197 ± | 0.8 | 89 ± | 0.3 | 82.8% |
| 10 | Nb2O5 | Ga2O3 | 1%/1% | 181.8 ± | 0.4 | 85.3 ± | 0.4 | 96.4% |
| 11 | Nb2O5 | Ga2O3 | 0.5%/0.5% | 192.1 ± | 0 | 87 ± | 0.05 | 93.3% |
| 12 | ANO | Ga2O3 | 1%/1% | 188.9 ± | 1.4 | 86.7 ± | 0.55 | 94.0% |
| 13 | ANO | Ga2O3 | 0.5%/0.5% | 195 ± | 0.55 | 88 ± | 0.35 | 82.7% |
| 14 | Nb2O5 | In2O3 | 1%/1% | 185.9 ± | 0.9 | 86.4 ± | 0.25 | 93.6% |
| 15 | Nb2O5 | In2O3 | 0.5%/0.5% | 194.6 ± | 0.05 | 87.6 ± | 0.1 | 91.0% |
| 16 | ANO | In2O3 | 1%/1% | 188.3 ± | 1.6 | 87.1 ± | 0.5 | 92.4% |
| 17 | ANO | In2O3 | 0.5%/0.5% | 188.7 ± | 1.2 | 85.4 ± | 0.5 | 93.1% |
| 18 | Nb2O5 | MgO | 1%/1% | 188 ± | 0.95 | 86.4 ± | 0.45 | 95.2% |
| 19 | Nb2O5 | MgO | 0.5%/0.5% | 194.1 ± | 0.8 | 87.3 ± | 0.25 | 93.7% |
| 20 | ANO | MgO | 1%/1% | 186.1 ± | 1.4 | 85.7 ± | 0.5 | 94.3% |
| 21 | ANO | MgO | 0.5%/0.5% | 193.1 ± | 0.55 | 86.8 ± | 0.3 | 88.8% |
| 22 | Nb2O5 | Ta2O5 | 1%/1% | 177.6 ± | 3.2 | 83.1 ± | 0.15 | 100.8% |
| 23 | Nb2O5 | Ta2O5 | 0.5%/0.5% | 186.4 ± | 1.5 | 84.7 ± | 0.5 | 102.0% |
| 24 | ANO | Ta2O5 | 1%/1% | 173.7 ± | 1.4 | 82.6 ± | 0.45 | 98.5% |
| 25 | ANO | Ta2O5 | 0.5%/0.5% | 182.8 ± | 5.15 | 83.3 ± | 1 | 96.7% |
| 26 | Nb2O5 | TiO2 | 1%/1% | 180.5 ± | 1.75 | 83.9 ± | 0.5 | 100.4% |
| 27 | Nb2O5 | TiO2 | 0.5%/0.5% | 194.9 ± | 0.45 | 87.6 ± | 0.35 | 89.5% |
| 28 | ANO | TiO2 | 1%/1% | 182.6 ± | 1.3 | 85 ± | 0.2 | 97.7% |
| 29 | ANO | TiO2 | 0.5%/0.5% | 194.3 ± | 1.5 | 87.4 ± | 0.45 | 87.5% |
| 30 | Nb2O5 | ZnCO3 | 1%/1% | 181.2 ± | 0.95 | 84 ± | 0.5 | 97.5% |
| 31 | Nb2O5 | ZnCO3 | 0.5%/0.5% | 192.7 ± | 2.4 | 87.4 ± | 0.85 | 90.2% |
| 32 | ANO | ZnCO3 | 1%/1% | 181.7 ± | 0.85 | 84.2 ± | 0.35 | 93.7% |
| 33 | ANO | ZnCO3 | 0.5%/0.5% | 184 ± | 1 | 83 ± | 0.35 | 98.1% |
| 34 | Nb2O5 | ZrO2 | 1%/1% | 180.3 ± | 1.65 | 84.9 ± | 0.6 | 94.8% |
| 35 | Nb2O5 | ZrO2 | 0.5%/0.5% | 195.3 ± | 1.25 | 87.2 ± | 0.25 | 95.9% |
| 36 | ANO | ZrO2 | 1%/1% | 182.2 ± | 1.1 | 85.6 ± | 0.3 | 93.0% |
| 37 | ANO | ZrO2 | 0.5%/0.5% | 189.4 ± | 2.05 | 86 ± | 0.25 | 92.4% |

The data in Table 3 shows that 30 of the 32 double-doped test cells retained at least 85% capacity after 140 discharge cycles, and 27 of the 32 retained at least 90% capacity. All of the double-doped test cells performed significantly superior with respect to capacity retention than the undoped control cell (Material 1), which had only 64% capacity retention. The best performers were Materials 22 and 23 which included niobium oxide as the niobium doping agent and Ta₂O₅ as the second metal doping agent. Other material compositions that performed particularly well included Material 26 (niobium oxide and TiO₂), Material 24 (ANO and Ta₂O₅), Material 33 (ANO and ZnCO₃), Material 28 (ANO and TiO₂), Material 30 (niobium oxide and ZnCO₃), and Material 6 (niobium oxide and Al₂O₃). Interestingly, the same combination of doping agents at the same concentration as Material 6 in Table 3 produced relatively low capacity retention (similar performance as the control material) when used in the NMC 622 bulk lattice as shown in Material 5 of Table 1. This data indicates that specific results were unpredictable. The capacity retention appears to rely on a variety of factors, including the composition of the NMC bulk lattice (e.g., whether 622 or 811), the identity of the two doping agents, and the concentrations of the two doping agents.

FIG. 2 is a graph 200 plotting cycling capacity retention for four of the test cells shown in Table 3. The plotted test cells include the baseline control cell (Material 1) and three double-doped layered oxide materials including Material 9, Material 29, and Material 37. The graph 200 indicates capacity retention in percentage over cycles 1 through 140. All three of the cells with double-doped layered oxide materials showed significantly better capacity retention than the baseline control cell (circle in FIG. 2), deviating around the thirtieth cycle. There is a stark difference in capacity retention between the three double-doped test cells and the control cell at the 140^{th} cycle. Material 37 (diamond in FIG. 2) had the greatest capacity retention at the 140^{th} cycle of the four tested cells, but was not one of the best performing double-doped NMC 811 layered oxide materials shown in Table 3.

Prior to cycle life testing, all test cells were subject to a discharge rate test (0.1 C/2 C). Table 4 below shows the rate capability results of the 37 electrochemical test cells having NMC 811 layered oxide cathode materials shown in Table 3.

TABLE 4
Rate capability results of various double-doped NMC 811 samples.

| | | | | Cy9 Cap | | Cy9 Ret |
|---|---|---|---|---|---|---|
| | Nb | M | Precursor | (C/10, 2C) | | (C/10, 2C) |
| Material | Precursor | Precursor | Conc. | (mAh/g) | | (%) |
| 1 | Baseline (no dopant) | | | 165.5 ± | 0.85 | 84.8% |
| 2 | Nb2O5 | — | 0.5% | 168.8 ± | 0.9 | 90.1% |
| 3 | Nb2O5 | — | 1% | 165.8 ± | 0.1 | 85.1% |
| 4 | ANO | — | 0.5% | 171.5 ± | 1.4 | 90.5% |
| 5 | ANO | — | 1% | 165.7 ± | 1.0 | 80.6% |
| 6 | Nb2O5 | Al2O3 | 1%/1% | 154.9 ± | 0.25 | 84.8% |
| 7 | Nb2O5 | Al2O3 | 0.5%/0.5% | 167.6 ± | 0.1 | 86.4% |
| 8 | ANO | Al2O3 | 1%/1% | 165.5 ± | 1.9 | 85.8% |
| 9 | ANO | Al2O3 | 0.5%/0.5% | 169.5 ± | 3.65 | 86.0% |
| 10 | Nb2O5 | Ga2O3 | 1%/1% | 151.9 ± | 1.55 | 83.6% |
| 11 | Nb2O5 | Ga2O3 | 0.5%/0.5% | 165.1 ± | 0.85 | 85.9% |
| 12 | ANO | Ga2O3 | 1%/1% | 162 ± | 1.3 | 85.8% |
| 13 | ANO | Ga2O3 | 0.5%/0.5% | 167.6 ± | 3.55 | 85.9% |
| 14 | Nb2O5 | In2O3 | 1%/1% | 158.2 ± | 0.7 | 85.1% |
| 15 | Nb2O5 | In2O3 | 0.5%/0.5% | 168.6 ± | 0.35 | 86.6% |
| 16 | ANO | In2O3 | 1%/1% | 160.7 ± | 1.35 | 85.3% |
| 17 | ANO | In2O3 | 0.5%/0.5% | 161.8 ± | 1.1 | 85.7% |
| 18 | Nb2O5 | MgO | 1%/1% | 161.8 ± | 1.05 | 86.0% |
| 19 | Nb2O5 | MgO | 0.5%/0.5% | 167.5 ± | 0.55 | 86.3% |
| 20 | ANO | MgO | 1%/1% | 158.4 ± | 1.8 | 85.1% |
| 21 | ANO | MgO | 0.5%/0.5% | 167.9 ± | 0.3 | 87.0% |
| 22 | Nb2O5 | Ta2O5 | 1%/1% | 147 ± | 2.95 | 82.8% |
| 23 | Nb2O5 | Ta2O5 | 0.5%/0.5% | 157.3 ± | 1.6 | 84.4% |
| 24 | ANO | Ta2O5 | 1%/1% | 142.2 ± | 0.8 | 81.8% |
| 25 | ANO | Ta2O5 | 0.5%/0.5% | 152.4 ± | 6.1 | 83.4% |
| 26 | Nb2O5 | TiO2 | 1%/1% | 151.6 ± | 1.55 | 84.0% |
| 27 | Nb2O5 | TiO2 | 0.5%/0.5% | 167.9 ± | 1.55 | 86.1% |
| 28 | ANO | TiO2 | 1%/1% | 155.1 ± | 1.3 | 84.9% |
| 29 | ANO | TiO2 | 0.5%/0.5% | 168.8 ± | 1.25 | 86.9% |
| 30 | Nb2O5 | ZnCO3 | 1%/1% | 155 ± | 0.9 | 85.6% |
| 31 | Nb2O5 | ZnCO3 | 0.5%/0.5% | 166.3 ± | 2.5 | 86.3% |
| 32 | ANO | ZnCO3 | 1%/1% | 155.7 ± | 0.9 | 85.7% |
| 33 | ANO | ZnCO3 | 0.5%/0.5% | 156.4 ± | 0.75 | 85.0% |
| 34 | Nb2O5 | ZrO2 | 1%/1% | 152 ± | 1.5 | 84.3% |
| 35 | Nb2O5 | ZrO2 | 0.5%/0.5% | 166.7 ± | 0.15 | 85.3% |
| 36 | ANO | ZrO2 | 1%/1% | 155.1 ± | 1.3 | 85.1% |
| 37 | ANO | ZrO2 | 0.5%/0.5% | 161.4 ± | 2.4 | 85.2% |

Compared to the baseline (non-doped) control cell, several double-doped layered oxide cathode cells showed both higher absolute 2 C discharge capacity and higher 2 C discharge capacity retention (relative to the 2^{nd} cycle 0.1 C/0.1 C). The best materials for high rate included Material 9 (e.g., ANO and Al₂O₃ at 0.5/0.5 wt %), Material 15 (e.g., Nb₂O₅ and In₂O₃ at 0.5/0.5 wt %), Material 27 (e.g., Nb₂O₅ and TiO₂ at 0.5/0.5 wt %), and Material 35 (e.g., Nb₂O₅ and ZrO₂ at 0.5/0.5 wt %).

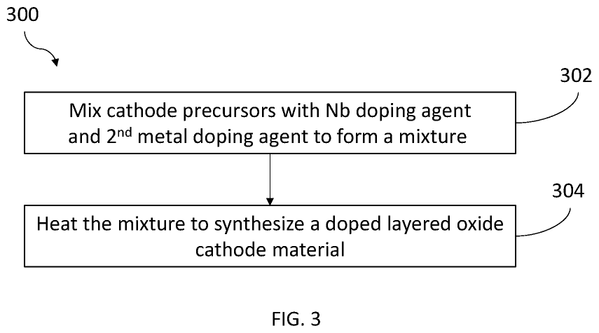

FIG. 3 is a flow chart 300 for a method of producing a layered oxide cathode material according to an embodiment. The method may include additional steps than shown in FIG. 3, fewer steps than shown in FIG. 3, and/or different steps than the steps shown in FIG. 3. At step 302, multiple cathode precursors are mixed with a niobium (Nb) doping agent and a second metal doping agent to form a mixture. The cathode precursors may be added at designated stoichiometric amounts according to a desired layered crystal structure. The cathode precursors may include lithium hydroxide (LiOH), cobalt(II,III) oxide (or cobalt tetraoxide) (CO₃O₄), manganese(II) carbonate (MnCO₃), and nickel(II) hydroxide (Ni(OH)₂) to form the NMC 622 bulk lattice structure. The cathode precursors may be added such that there is an atomic ratio of at least 3:1:1 nickel to manganese to cobalt (e.g., at least 3:1 nickel to each of manganese and cobalt). To form the NMC 811 bulk lattice structure, the cathode precursors may include Ni_{0.8}Mn_{0.1}Co_{0.1}(OH)₂ and lithium carbonate (Li₂CO₃). The niobium doping agent may be niobium oxide (Nb₂O₅) or ANO. The second metal doping agent may be aluminum oxide (Al₂O₃), gallium oxide (Ga₂O₃), indium oxide (In₂O₃), magnesium oxide (MgO), tantalum oxide (Ta₂O₅), titanium dioxide (TiO₂), zinc carbonate (ZnCo₃), or zirconium dioxide (ZrO₂).

At 304, the mixture is heated to synthesize the double-doped layered oxide cathode material. The heating step may include heating the mixture at a designated temperature or temperature range for a designated time period or time range. The designated temperature may be at least 700° C. The time period may be at least 3 hours, at least 5 hours, at least 8 hours, at least 12 hours, or at least 15 hours. In an embodiment, to synthesize the double-doped NMC 622 layered oxide material, the mixture may be heated at 750° C. for 16 hours. To synthesize the double-doped NMC 811 layered oxide material, the mixture may be heated at a higher temperature, such as 850° C. and/or may be heated for a longer duration, such as 10 hours, 15 hours, or 20 hours. The heating step may occur in the presence of a continuous gas flow, such as air or pure oxygen.

Optionally, the method may include milling the mixture in a small amount of water prior to the heating step at 304 to homogenize the precursors and doping agents.

The doped nickel-rich layered oxide materials according to the embodiments described herein can be used to produce a lithium ion battery. The lithium ion battery includes a cathode, an anode, an electrolyte, and optionally a separator. The doped nickel-rich layered oxide material is used as the cathode active material of the cathode. For example, the doped nickel-rich layered oxide material may be applied to an aluminum current collector to define the cathode.

The lithium ion battery may be a secondary battery, such that the battery is rechargeable. Discharging and charging of the battery may be accomplished by reversible intercalation and de-intercalation, respectively, of lithium ions into and from the host materials of the anode and the cathode. The voltage of the battery may be based on redox potentials of the anode and the cathode, where lithium ions are accommodated or released at a lower potential in the former and a higher potential in the latter.

Examples of suitable anode materials include conventional anode materials used in lithium ion batteries, such as lithium, graphite (“LiₓC₆”), silicon, and other carbon, silicate, or oxide-based anode materials, as well as composite alloys that combine multiple anode materials.

The electrolyte may include at least one organic solvent and at least one lithium salt. The organic solvent(s) can include one or more carbonates, such as ethylene carbonate (EC), ethyl methyl carbonate (“EMC”), diethyl carbonate (“DEC”), fluoroethylene carbonate (“FEC”), trifluoropropylene carbonate (“TFPC”), propylene carbonate (“PC”), and/or the like. The lithium salt may include lithium hexafluorophosphate (LiPF₆), lithium bis(fluorosulfonyl)imide (“LiFSI”), lithium difluoro(oxalato)borate (“LiDFOB”) (LiBF₂(C₂O₄), and/or the like. The electrolyte may be in the liquid phase, the solid phase, a gel phase, or another non-solid phase.

In an embodiment, a layered oxide material is provided that includes a bulk lattice, a niobium (Nb) dopant, and a second dopant. The bulk lattice includes lithium (Li), nickel (Ni), manganese (Mn), cobalt (Co), and oxygen (O). The second dopant includes one of aluminum (Al), gallium (Ga), indium (In), magnesium (Mg), tantalum (Ta), titanium (Ti), zinc (Zn), or zirconium (Zr).

Optionally, an atomic ratio of the nickel in the bulk lattice to the manganese and the cobalt is at least 3:1:1.

Optionally, the niobium dopant and the second dopant are doped onto a transition metal site of the bulk lattice occupied by one or more of the nickel, the manganese, or the cobalt.

Optionally, the niobium dopant and the second dopant are doped onto a site of the bulk lattice occupied by the lithium.

Optionally, the layered oxide material is represented by the chemical formula (a):

Li_{z}Ni_{0.6-(x+y)/3}Mn_{0.2-(x+y)/3}Co_{0.2-(x+y)/3}NbₓMyO₂ (a)

wherein x+y<0.6, 0.95≤z≤1.1, and M is one of aluminum, gallium, indium, magnesium, tantalum, titanium, zinc, or zirconium.

Optionally, the layered oxide material is represented by the chemical formula (b):

Li_{z-x-y}Ni_{0.8}Mn_{0.1}Co_{0.1}NbₓM_{y}O₂ (b)

wherein x+y<z, 0.95≤z≤1.1, and M is one of aluminum, gallium, indium, magnesium, tantalum, titanium, zinc, or zirconium.

Optionally, the second dopant comprises aluminum. Optionally, the second dopant comprises gallium. Optionally, the second dopant comprises indium. Optionally, the second dopant comprises magnesium. Optionally, the second dopant comprises tantalum. Optionally, the second dopant comprises titanium. Optionally, the second dopant comprises zinc. Optionally, the second dopant comprises zirconium.

In an embodiment, a lithium ion battery is provided that includes a cathode, an anode, and an electrolyte. The cathode is capable of reversible intercalation of lithium ions. The cathode includes a layered oxide material, which has a bulk lattice, a niobium dopant, and a second dopant. The bulk lattice includes lithium, nickel, manganese, cobalt, and oxygen. The second dopant includes one of aluminum, gallium, indium, magnesium, tantalum, titanium, zinc, or zirconium. The electrolyte includes an organic solvent and a lithium salt.

Optionally, the layered oxide material is represented by the chemical formula (a):

Li_{z}Ni_{0.6-(x/3)-(y/3)}Mn_{0.2-(x/3)-(y/3)}Co_{0.2-(x/3)-(y/3)}NbₓM_{y}O₂ (a)

wherein x+y<0.6, 0.95≤z≤1.1, and M is one of aluminum, gallium, indium, magnesium, tantalum, titanium, zinc, or zirconium.

Optionally, the layered oxide material is represented by the chemical formula (b):

Li_{z-x-y}Ni_{0.8}Mn_{0.1}Co_{0.1}NbₓM_{y}O₂ (b)

wherein x+y<z, 0.95≤z≤1.1, and M is one of aluminum, gallium, indium, magnesium, tantalum, titanium, zinc, or zirconium.

In an embodiment, a method for producing a layered oxide material is provided. The method includes mixing stoichiometric amounts of multiple cathode precursors with a niobium doping agent and a second metal doping agent to form a mixture. The second metal doping agent includes one of aluminum, gallium, indium, magnesium, tantalum, titanium, zinc, or zirconium. The method also includes heating the mixture to synthesize the layered oxide material.

Optionally, the niobium doping agent is one of niobium oxide (Nb₂O₅) or ammonium niobium oxalate (“ANO”), and the second metal doping agent is one of aluminum oxide (Al₂O₃), gallium oxide (Ga₂O₃), indium oxide (In₂O₃), magnesium oxide (MgO), tantalum oxide (Ta₂O₅), titanium dioxide (TiO₂), zinc carbonate (ZnCo₃), or zirconium dioxide (ZrO₂).

Optionally, the heating comprises heating the mixture at a temperature of at least 700° C.

As used herein, value modifiers such as “about,” “substantially,” and “approximately” inserted before a numerical value indicate that the value can represent other values within a designated threshold range above and/or below the specified value, such as values within 5%, 10%, or 15% of the specified value.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A layered oxide material comprising:
a bulk lattice comprising lithium (Li), nickel (Ni), manganese (Mn), cobalt (Co), and oxygen (O),
a niobium (Nb) dopant; and
a second dopant that comprises one of aluminum (Al), gallium (Ga), indium (In), magnesium (Mg), tantalum (Ta), titanium (Ti), zinc (Zn), or zirconium (Zr).

2. The layered oxide material of claim 1, wherein an atomic ratio of the nickel in the bulk lattice to the manganese and the cobalt is at least 3:1:1.

3. The layered oxide material of claim 1, wherein the niobium dopant and the second dopant are doped onto a transition metal site of the bulk lattice occupied by one or more of the nickel, the manganese, or the cobalt.

4. The layered oxide material of claim 1, wherein the niobium dopant and the second dopant are doped onto a site of the bulk lattice occupied by the lithium.

5. The layered oxide material of claim 1, wherein the layered oxide material is represented by the chemical formula (a):
Li_{z}Ni_{0.6-(x+y)/3}Mn_{0.2-(x+y)/3}Co_{0.2-(x+y)/3)}NbₓM_{y}O₂ (a)
wherein x+y<0.6, 0.95≤z≤1.1, and M is one of aluminum, gallium, indium, magnesium, tantalum, titanium, zinc, or zirconium.

6. The layered oxide material of claim 1, wherein the layered oxide material is represented by the chemical formula (b):
Li_{z-x-y}Ni_{0.8}Mn_{0.1}Co_{0.1}NbₓM_{y}O₂ (b)
wherein x+y<z, 0.95≤z≤1.1, and M is one of aluminum, gallium, indium, magnesium, tantalum, titanium, zinc, or zirconium.

7. The layered oxide material of claim 1, wherein the second dopant comprises aluminum.

8. The layered oxide material of claim 1, wherein the second dopant comprises gallium.

9. The layered oxide material of claim 1, wherein the second dopant comprises indium.

10. The layered oxide material of claim 1, wherein the second dopant comprises magnesium.

11. The layered oxide material of claim 1, wherein the second dopant comprises tantalum.

12. The layered oxide material of claim 1, wherein the second dopant comprises titanium.

13. The layered oxide material of claim 1, wherein the second dopant comprises zinc.

14. The layered oxide material of claim 1, wherein the second dopant comprises zirconium.

15. A lithium ion battery comprising:
a cathode capable of reversible intercalation of lithium ions, the cathode comprising a layered oxide material, the layered oxide material comprising:
a bulk lattice comprising lithium (Li), nickel (Ni), manganese (Mn), cobalt (Co), and oxygen (O),
a niobium (Nb) dopant; and
a second dopant that comprises one of aluminum (Al), gallium (Ga), indium (In), magnesium (Mg), tantalum (Ta), titanium (Ti), zinc (Zn), or zirconium (Zr);
an anode; and
an electrolyte comprising an organic solvent and a lithium salt.

16. The lithium ion battery of claim 15, wherein the layered oxide material is represented by the chemical formula (a):
Li_{z}Ni_{0.6-(x/3)-(y/3)}Mn_{0.2-(x/3)-(y/3)}Co_{0.2-(x/3)-(y/3)}NbₓM_{y}O₂ (a)
wherein x+y<0.6, 0.95≤z≤1.1, and M is one of aluminum, gallium, indium, magnesium, tantalum, titanium, zinc, or zirconium.

17. The lithium ion battery of claim 15, wherein the layered oxide material is represented by the chemical formula (b):
Li_{z-x-y}Ni_{0.8}Mn_{0.1}Co_{0.1}NbₓM_{y}O₂ (b)
wherein x+y<z, 0.95≤z≤1.1, and M is one of aluminum, gallium, indium, magnesium, tantalum, titanium, zinc, or zirconium.

18. A method for producing a layered oxide material, the method comprising:
mixing stoichiometric amounts of multiple cathode precursors with a niobium (Nb) doping agent and a second metal doping agent to form a mixture, the second metal doping agent comprising one of aluminum (Al), gallium (Ga), indium (In), magnesium (Mg), tantalum (Ta), titanium (Ti), zinc (Zn), or zirconium (Zr); and
heating the mixture to synthesize the layered oxide material.

19. The method of claim 18, wherein the niobium doping agent is one of niobium oxide (Nb₂O₅) or ammonium niobium oxalate (“ANO”), and the second metal doping agent is one of aluminum oxide (Al₂O₃), gallium oxide (Ga₂O₃), indium oxide (In₂O₃), magnesium oxide (MgO), tantalum oxide (Ta₂O₅), titanium dioxide (TiO₂), zinc carbonate (ZnCo₃), or zirconium dioxide (ZrO₂).

20. The method of claim 18, wherein the heating comprises heating the mixture at a temperature of at least 700° C.
